(19) United States
(12) Patent Application Publication
(10) Pub. No.: US 2007/0092232 A1
(43) Pub. Date: Apr. 26, 2007

(54) Motor drive unit

(76) Inventor: Norio Fujii, Kyoto (JP)

Correspondence Address: CANTOR COLBURN, LLP, 55 GRIFFIN ROAD SOUTH, BLOOMFIELD, CT, 06002, US

(21) Appl. No.: 11/583,249

(22) Filed: Oct. 19, 2006

(30) Foreign Application Priority Data
Oct. 21, 2005 (JP) JP2005-307829

(51) Int. Cl. H02P 7/285

(52) U.S. Cl. 388/814

(57) ABSTRACT

A motor drive unit (100) includes a pulse train generator 38, a clock signal generator (18), and an energization signal generator (20). The pulse train generator (38) creates a pulse each time an edge of a square wave signal (Vrct) is detected, and generates a pulse train (Vpls). The clock signal generator (18) generates a clock signal (Vclk) having a frequency N times a frequency of the pulse train (Vpls). The energization signal generator (20) generates an energization signal having a level that designates energization for a coil of a motor (102), for a time period in which the clock signal (Vclk) is counted M times, and, after that, having a level that indicates non-energization for the coil, for a time period in which the clock signal (Vclk) is counted (N−M) times.

### BACKGROUND OF THE INVENTION

1. Field of the Invention

The present invention relates to drive technology for motors, and in particular, to a motor drive unit for driving a single phase motor and to electronic devices using the motor drive unit.

2. Description of the Related Art

Generally, when a single phase brushless motor is driven, based on a position of a rotor detected by a sensor such as a Hall element or the like, timing of switching direction of a current supplying a motor coil (below, referred to as “current switching timing”) is detected. In order to realize smaller motors, a drive unit of a single phase brushless motor that detects the current switching timing without using a sensor such as a Hall element or the like, has been proposed (Patent Document 1). In cases of a single phase motor, by detecting a zero crossing in induced voltage generated in the motor coil, the current switching timing can be detected.

Patent Document 1: Japanese Patent Application, Laid Open No. S63-11085

In order to detect the zero crossing of the induced voltage, technology of Patent Document 1 measures half a revolution period of a rotor from the previous zero crossing of the induced voltage to the present zero crossing, and by this measured value, by arithmetically setting a waiting period from a zero point of the induced voltage generated in the motor coil to a start of energization, and an energization time period of the motor coil, energization of the motor coil in a vicinity of the zero crossing is shut off.

However, in cases in which the energization time period of the motor coil is arithmetically set, there is a problem in that an arithmetic circuit is necessary, and circuit size becomes large.

### SUMMARY OF THE INVENTION

The present invention has been made in view of the foregoing circumstances, and a general purpose thereof is to provide a motor drive unit that can control energization time period of a motor coil by a configuration in which circuit size is curtailed, and to provide an electronic device using the unit.

In order to solve the abovementioned problems, a motor drive unit according to one embodiment of the present invention includes a comparator for comparing a voltage occurring at two ends of a coil of a single phase motor, and outputting a square wave signal, a pulse train generator for creating a pulse every time an edge of the square wave signal is detected, and for generating a pulse train, and an energization signal generator for dividing a period of the pulse train at a prescribed ratio into a first half and a latter half by counting a clock count of a clock signal that has a frequency proportional to number of revolutions of the single phase motor, and for generating an energization signal having a first level designating energization of the coil in the first half, and a second level designating non-energization of the coil in the latter half. An output circuit for supplying a drive current to the coil based on the square wave signal and the energization signal may additionally be provided.

According to this embodiment, since the energization signal generator generates the energization signal that switches energization of the coil by counting the clock count of the clock signal that has a frequency proportional to the number of revolutions of the single phase motor, it is possible to control the energization time period of the coil by a configuration in which the circuit size is curtailed.

A clock signal generator may additionally be provided for generating a clock signal that has a frequency that is N times (N being a natural number greater than or equal to 2) the frequency of the pulse train. The energization signal generator may generate an energization signal having the first level, for a time period in which the clock signal is counted M times after pulse creation (M being a natural number, M<N), and, after that, having the second level, for a time period in which the clock signal is counted (N−M) times.

In this case, since the energization signal generator generates the energization signal having the first level, for a time period in which the clock signal, which has a frequency of N times the frequency of the pulse train, is counted M times after pulse creation, and, after that, having the second level, for a time period in which the clock signal is counted (N−M) times, even in cases in which the number of revolutions of the motor changes, the energization time period can be automatically controlled.

The pulse train generator may include an edge detection circuit for creating a pulse every time an edge of the square wave signal is detected, and generating the pulse train, and a mask processor for masking the pulse, for a prescribed noise elimination time period.

In this case, since the mask processor masks the pulse created to detect an edge in the noise elimination time period, malfunctions due to noise can be reduced.

With N as a natural number greater than or equal to 3, the mask processor may mask the pulse for a time period in which the clock signal is counted L times (L being a natural number, L<(N−M)), after the energization signal has transited from the first level to the second level.

In this case, even if the number of revolutions of the motor changes, the noise elimination time period can be automatically controlled. Furthermore, malfunctions due to noise generated due to the energization signal transiting from the first level to the second level can be reduced.

A pulse train generator may include a mask processor that nullifies transition of level of the square wave signal, for a prescribed noise elimination time period, and an edge detection circuit for creating a pulse every time an edge of the square wave signal, outputted from the mask processor, is detected, and for generating the pulse train.

In this case, since the edge detection circuit creates a pulse every time an edge of the square wave signal, for which the transition of level has been nullified in the noise elimination time period, is detected, risk that an edge produced by noise will be detected, is reduced.

With N as a natural number greater than or equal to 3, the mask processor may nullify the transition of level of the square wave signal for a time period in which the clock signal is counted L times (L being a natural number, L<(N−M)), after the energization signal has transited from the first level to the second level.

In this case, even if the number of revolutions of the motor changes, the time period in which the transition of level of the square wave signal is nullified, can be automatically controlled.

A gradient signal generator for outputting a gradient signal in which electrical potential gradually changes at an occasion of transition of level of the energization signal, and an output circuit for gradually changing a drive current supplied to the coil of the single phase motor based on the gradient signal, may additionally be provided.

In this case, since the output circuit gradually changes the drive current supplied to the coil of the single phase motor based on the gradient signal, the noise can be reduced.

The gradient signal generator may include an up-down counter for counting up or counting down according to transition direction when the energization signal transits between the first level and the second level, and a digital-analog conversion circuit for converting a count value of the up-down counter to an analog signal. An output signal of the digital-analog conversion circuit may be output as a gradient signal.

The clock signal generator may include a phase synchronization circuit. The gradient signal generator may include a capacitor in which one extremity of the electrical potential is fixed, and a charge-discharge unit for generating a current in response to a voltage input to a voltage control oscillator included in the phase synchronization circuit, and for charging or discharging the capacitor by the generated current. The charge-discharge unit may switch between charging and discharging according to the level of the energization signal.

The motor drive unit may be integrated on one semiconductor board. Moreover, “integrated” includes cases in which all constituent elements of the circuit are formed on a semiconductor board, and cases in which main constituent elements of the circuit are integrated, with some capacitors or resistors for adjusting a circuit constant arranged outside the semiconductor board. By integrating the motor drive unit as one LSI, the circuit area can be reduced.

Another embodiment of the present invention relates to an electronic device. The electronic device includes a single phase motor, and a motor drive unit for driving the single phase motor. According to this embodiment, since the energization time period for the coil can be controlled via a simple configuration, the electronic device can be made small.

Furthermore, optional combinations of the above constituent elements, and representations of the present invention in which methods, devices, systems, and the like, are changed, are valid as embodiments of the invention.

### BRIEF DESCRIPTION OF THE DRAWINGS

FIG. 1 is a circuit diagram showing a configuration of an electronic device related to a first embodiment;

FIG. 2A is a circuit diagram showing a configuration of an edge detection circuit included in a pulse train generator of FIG. 1;

FIG. 2B is timing chart showing operation of the edge detection circuit of FIG. 2A;

FIG. 3 is a timing chart showing operation of the electronic device of FIG. 1;

FIG. 4 is a circuit diagram showing a configuration of an electronic device related to a second embodiment;

FIG. 5 is a timing chart of a mask processing operation in a pulse train generator of FIG. 4;

FIG. 6 is a circuit diagram showing a configuration of an electronic device related to a third embodiment;

FIG. 7 is a circuit diagram showing a configuration of a gradient signal generator of FIG. 6;

FIG. 8 is a timing chart showing operation of the electronic device of FIG. 6;

FIG. 9. is a circuit diagram showing a configuration of an electronic device related to a fourth embodiment;

FIG. 10. is a circuit diagram showing a configuration of a distributor of FIG. 9;

FIG. 11. is a circuit diagram showing a configuration of a pulse train generator related to a modified example; and

FIG. 12. is a circuit diagram showing a configuration of a gradient signal generator and a clock signal generator related to the modified example.

### DETAILED DESCRIPTION OF THE INVENTION

The invention will now be described by reference to the preferred embodiments. This does not intend to limit the scope of the present invention, but to exemplify the invention.

### First Embodiment

An embodiment relates to an electronic device such as, for example, a mobile phone, or the like.

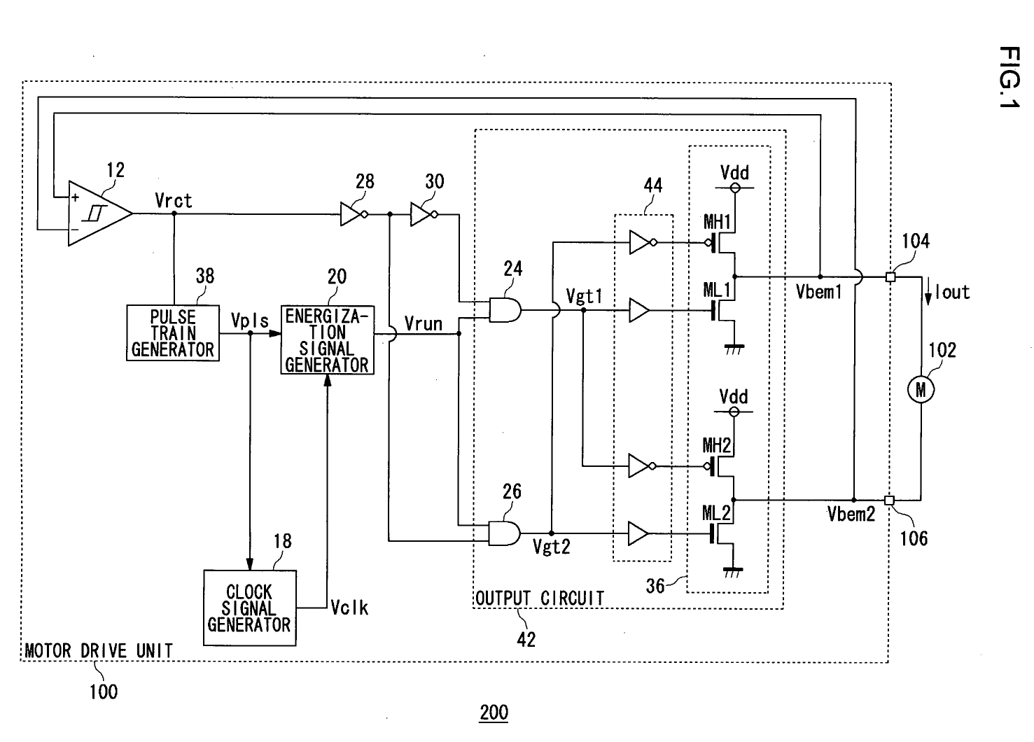

FIG. 1 shows a configuration of the electronic device 200 related to the first embodiment. The electronic device 200 is provided with a motor drive unit 100 and a motor 102.

The motor 102 is connected to a load such as, for example, a vibrator of the mobile telephone, or the like.

The motor drive unit 100 is provided with a first output terminal 104 and a second output terminal 106, forming a gateway for the drive current Iout for driving the motor 102.

The motor drive unit 100 supplies the drive current Iout to the motor 102, based on counter electromotive voltages Vbem1 and Vbem2 occurring at the first output terminal 104 and the second output terminal 106. The motor drive unit 100 is a function IC integrated on one semiconductor board.

The motor drive unit 100 is provided with a hysteresis comparator 12, a pulse train generator 38, a clock signal generator 18, an energization signal generator 20, and an output circuit 42.

The hysteresis comparator 12 compares the counter electromotive voltages Vbem1 and Vbem2, and outputs a square wave signal Vrct, at a high level when Vbem1>Vbem2, and at a low level when Vbem1<Vbem2.

The pulse train generator 38 creates a pulse each time an edge of the square wave signal Vrct is detected, and generates a pulse train Vpls. The pulse train Vpls is a signal that produces a pulse when the edge of the square wave signal Vrct is detected.

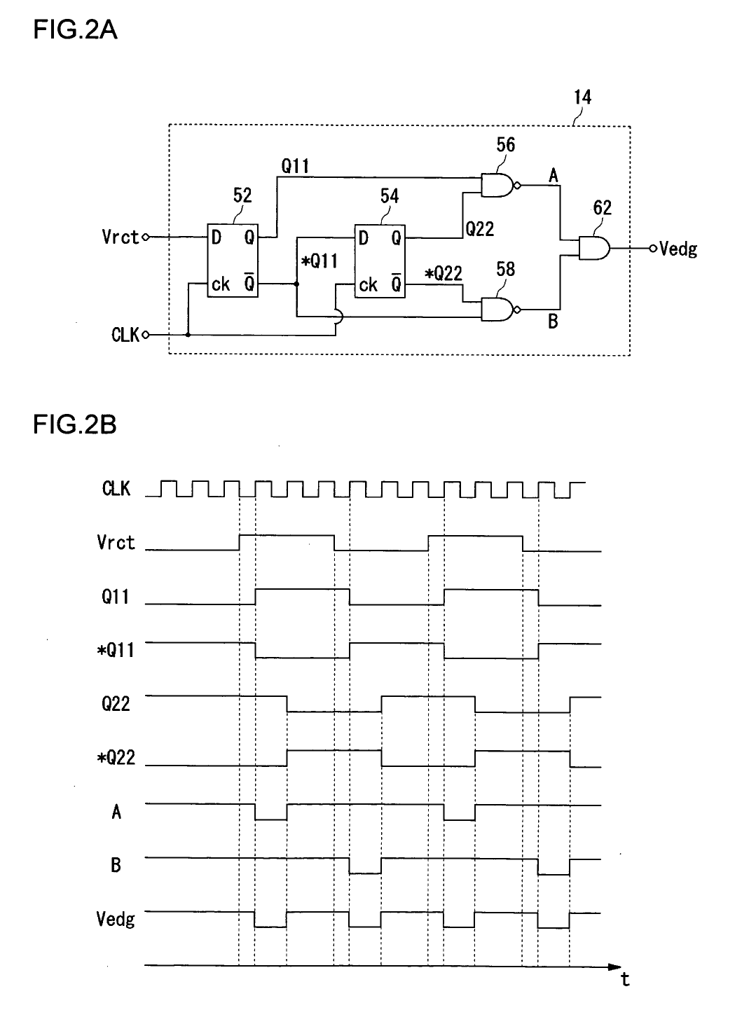

The pulse train generator 38 is configured to include an edge detection circuit 14, which is not shown in FIG. 1. FIG. 2A shows a configuration of the edge detection circuit 14 that is included in the pulse train generator 38 of FIG. 1. In the first embodiment, the pulse train Vpls is an edge detection signal Vedg itself, that is outputted by the edge detection circuit 14.

The edge detection circuit 14 includes Delay flip-flops 52 and 54 (referred to as “D flip-flops”), NAND gates 56 and 58, and an AND gate 62.

An external clock CLK is inputted to clock terminals of the D flip-flop 52 and the D flip-flop 54. The square wave signal Vrct is inputted to a data terminal of the D flip-flop 52. An inverted output terminal of the D flip-flop 52 is connected to the data terminal of the D flip-flop 54. An output terminal of the D flip-flop 52 and an output terminal of the D flip-flop 54 are connected to two input terminals of the NAND gate 56. An inverted output terminal of the D flip-flop 52 and an inverted output terminal of the D flip-flop 54 are connected to two input terminals of the NAND gate 58. The output terminals of the NAND gate 56 and 58 are connected to two input terminals of the NAND gate 62.

Voltage of the output terminal of the D flip-flop 52 is Q11, voltage of the output terminal of the D flip-flop 54 is Q22, voltage of the inverted output terminal of the D flip-flop 52 is *Q11, voltage of the inverted output terminal of the D flip-flop 54 is *Q22, output voltage of the NAND gate 56 is A, output voltage of the NAND gate 58 is B, and output voltage of the edge detection circuit 14 is the edge detection signal Vedg.

FIG. 2B is a timing chart showing operation of the edge detection circuit 14 of FIG. 2A. The timing chart of FIG. 2B shows, from the top, in order, the external clock CLK, the square wave signal Vrct, Q11, *Q11, Q22, *Q22, A, B, and the edge detection signal Vedg. In the same figure, a vertical axis and a horizontal axis are enlarged or reduced, as appropriate.

During one clock cycle from a rising edge of the external clock CLK that first occurs, after a rising edge and a falling edge of the square wave signal Vrct, the edge detection signal Vedg indicates a low level.

The explanation now returns to FIG. 1.

The clock signal generator 18 is configured from, for example, a PLL (Phase Locked Loop) or the like, and generates a clock signal Vclk having a frequency that is N times the frequency of the pulse train Vpls (N is a natural number greater than or equal to 2). That is, a clock signal Vclk having a frequency proportional to the number of revolutions of the motor 102 is generated. In the explanation below, N=1000.

The energization signal generator 20 generates an energization signal Vrun that has a high level for a time period (referred to below as an “energization time period”) in which the clock signal Vclk is counted M times (M is a natural number, M<N) after the pulse train generator 38 has created a pulse, and, after that, has a low level for a time period in which the clock signal Vclk is counted (N−M) times. In the explanation below, M=800. That is, the energization signal generator 20 divides a period of the pulse train into a first half and a latter half, at a ratio of 4:1.

The output circuit 42 outputs the drive current Iout to the motor 102, based on the square wave signal Vrct and the energization signal Vrun.

The output circuit 42 includes AND gates 24 and 26, a pre-driver 44, and a power transistor circuit 36.

The AND gate 24 computes a logical AND operation of the energization signal Vrun and the square wave signal Vrct inversed by a NOT gate 28 and a NOT gate 30, and outputs the computation result as a first gate control signal Vgt1. The AND gate 26 computes a logical AND operation of the energization signal Vrun and the square wave signal Vrct inversed by the NOT gate 28, and outputs the computation result as a second gate control signal Vgt2.

The pre-driver 44 performs ON-OFF control of a first lowside switch ML1 and a second highside switch MH2, based on the first gate control signal Vgt1. The pre-driver 44 performs ON-OFF control of a first highside switch MH1 and a second lowside switch ML2, based-on the second gate control signal Vgt2.

The power transistor circuit 36 includes the first highside switch MH1, the second highside switch MH2, the first lowside switch ML1, and the second lowside switch ML2. The first highside switch MH1 and the second highside switch MH2 are P-channel MOSFETs (Metal Oxide Semiconductor Field Effect Transistors), and the first lowside switch ML1 and the second lowside switch ML2 are N-channel MOSFETs.

The first highside switch MH1 and the first lowside switch ML1 are connected in series between a power supply line to which a power supply voltage Vdd is applied and grounding. The voltage of the connection point of the first highside switch MH1 and the first lowside switch ML1 is applied to one end of the motor 102 via the first output terminal 104. The voltage applied to the motor 102 via the first output terminal 104 is the power supply voltage Vdd when the first highside switch MH1 is ON, and the first lowside switch ML1 is OFF, and is grounding potential 0 V when the first highside switch MH1 is OFF, and the first lowside switch ML1 is ON.

In the same way, the second highside switch MH2 and the second lowside switch ML2 are connected in series between the power supply line and grounding. The voltage of the connection point of the second highside switch MH2 and the second lowside switch ML2 is applied to the other end of the motor 102 via the second output terminal 106.

ON-OFF states of the first highside switch MH1, the first lowside switch ML1, the second highside switch MH2, and the second lowside switch ML2 are controlled by the first gate control signal Vgt1 and the second gate control signal Vgt2, inputted to respective gates via the pre-driver 44. That is, the first highside switch MH1 and the second lowside switch ML2 are ON when the second gate control signal Vgt2 has a high level, and are OFF when the second gate control signal Vgt2 has a low level. Moreover, the first lowside switch ML1 and the second highside switch MH2 are ON when the first gate control signal Vgt1 has a high level, and are OFF when the first gate control signal Vgt1 has a low level.

Operation of the electronic device 200 according to the abovementioned configuration will be explained.

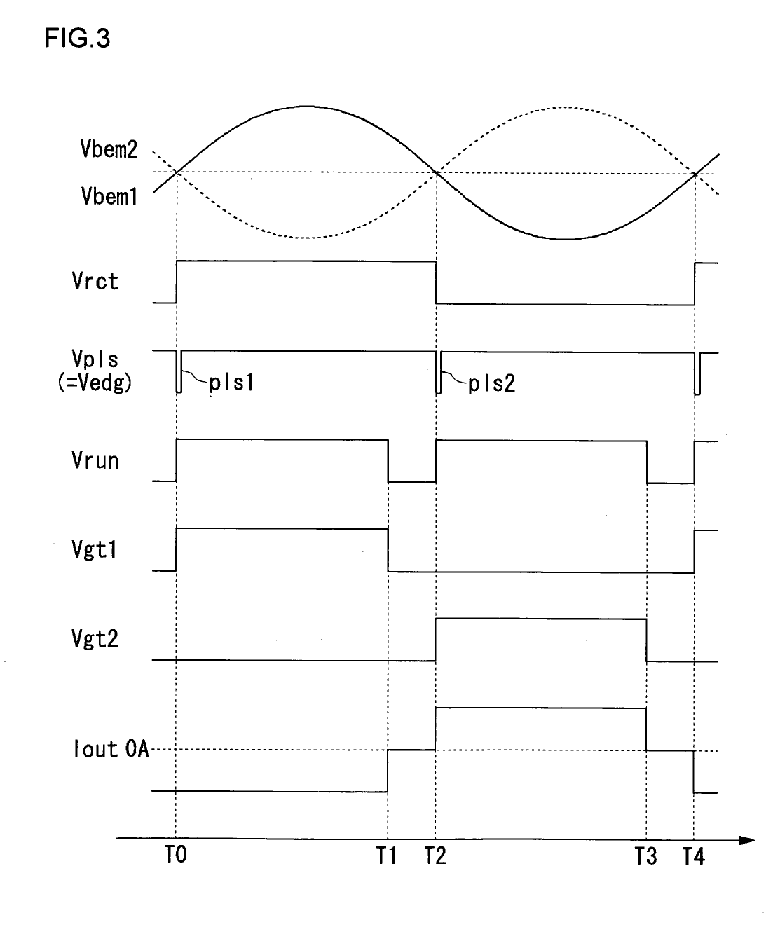

FIG. 3. is a timing chart showing the operation of the electronic device 200 of FIG. 1. The timing chart of FIG. 3 shows, from the top, in order, the counter electromotive voltages Vbem1 and Vbem2, the square wave signal Vrct, the pulse train Vpls, the energization signal Vrun, the first gate control signal Vgt1, the second gate control signal Vgt2, and the drive power source Iout. In the same figure, a vertical axis and a horizontal axis are enlarged or reduced, as appropriate.

At time T0, Vbem1>Vbem2, and the square wave signal Vrct transits from a low level to a high level. The pulse train generator 38 detects a rising edge of the square wave signal Vrct, and outputs the pulse pls1. The energization signal Vrun shows a high level while the clock signal Vclk is counted M times from when the pulse pls1 has been created. At the time T1 when M times have been counted, the energization signal Vrun transits to a low level.

The first gate control signal Vgt1 has a high level for a time period from time T0 to T1, at which both the square wave signal Vrct and the energization signal Vrun have a high level, and the first lowside switch ML1 and the second highside switch MH2 are ON. Accordingly, the drive current Iout flows from the second output terminal 106 towards the first output terminal 104. In the period from time T1 to T2, the energization signal Vrun has a low level, and both the first gate control signal Vgt1 and the second gate control signal Vgt2 have a low level. As result, the first highside switch MH1, the first lowside switch ML1, the second highside switch MH2, and the second lowside switch ML2 are all OFF, and the drive current Iout is OA.

At time T2, Vbem1<Vbem2, and the square wave signal Vrct transits from a high level to a low level. The pulse train generator 38 detects a falling edge of the square wave signal Vrct, and outputs the pulse pls2. The energization signal Vrun shows a high level while the clock signal Vclk is counted M times from when the pulse pls2 has been created. At time T3 when M times have been counted, the energization signal Vrun transits to a low level.

The second gate control signal Vgt2 has a high level for a time period from time T2 to T3, at which the square wave signal Vrct has a low level and the energization signal Vrun has a high level, and the first highside switch MH1 and the second lowside switch ML2 are ON. Accordingly, the drive current Iout flows from the first output terminal 104 towards the second output terminal 106. In the period from time T3 to T4, the energization signal Vrun has a low level, and both the first gate control signal Vgt1 and the second gate control signal Vgt2 have a low level. As a result, the first highside switch MH1, the first lowside switch ML1, the second highside switch MH2, and the second lowside switch ML2 are all OFF, and the drive current Iout is OA.

In this way, according to the electronic device 200 of the present embodiment, the clock signal generator 18 generates the clock signal Vclk that has a frequency N times the frequency of the pulse train Vpls, the energization signal generator 20 generates the energization signal Vrun that has a high level for a time period in which the clock signal Vclk is counted M times, after the pulse train generator 38 creates the pulse, and, after that, has a low level for a time period the clock signal Vclk is counted (N−M) times, so that, compared to cases in which the energization time period is controlled using an arithmetic circuit, the circuit size can be reduced. Furthermore, since, if the number of revolutions of the motor 102 changes, the emergent frequency of the edges of the square wave signal Vrct, that is, the frequency of the pulse train Vpls, changes in proportion thereto, the frequency of the clock signal Vclk also changes proportionately. Accordingly, the energization time period for the motor 102 is automatically controlled.

### Second Embodiment

In the first embodiment, the pulse train generator 38 outputted, as it is, the edge detection signal Vedg, which is outputted from the edge detection circuit 14 included inside the pulse train generator 38, as the pulse train Vpls; in a second embodiment, however, an explanation is given concerning cases in which the pulse train generator 38 has a mask processing function for noise suppression. Furthermore, in cases of the second embodiment, N is a natural number, greater than or equal to 3.

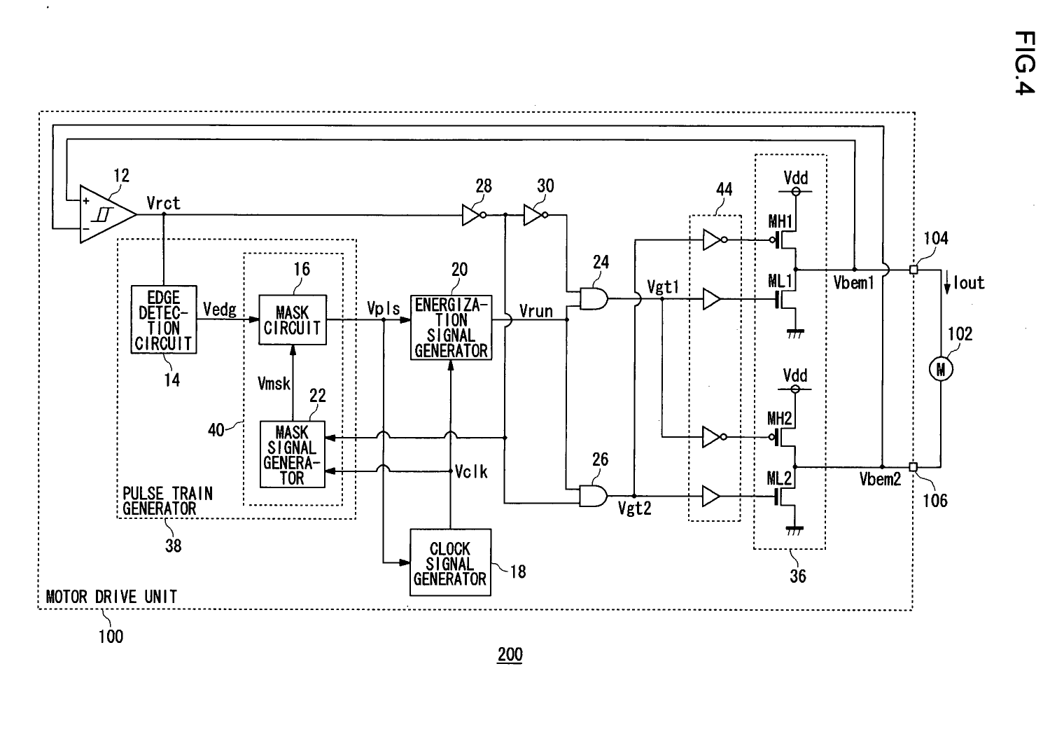

FIG. 4 shows a configuration of an electronic device 200 related to the second embodiment. In FIG. 4, constituent elements that are identical with or equivalent to constituent elements of FIG. 1 are given the same reference symbols, and explanations thereof are omitted as appropriate.

The pulse train generator 38 includes an edge detection circuit 14 and a mask processor 40.

The edge detection circuit 14 creates a pulse every time an edge of a square wave signal Vrct is detected, and generates an edge detection signal Vedg. The edge detection signal Vedg is a signal that produces a pulse when the edge of the square wave signal Vrct is detected.

The mask processor 40 masks a pulse of the edge detection signal Vedg, for a time period (referred to as a “mask processing time period”) in which a clock signal Vclk is counted L times (L is a natural number, L<(N−M)), after the energization signal Vrun transits from a high level to a low level. In the explanation below, L=150.

The mask processor 40 includes a mask circuit 16, and a mask signal generator 22.

The mask signal generator 22 outputs a mask signal Vmsk that has a high level, in the mask processing time period. The mask circuit 16 masks the pulse of the edge detection signal Vedg for the mask processing time period, by a logic operation on the edge detection signal Vedg and the mask signal Vmsk. That is, the edge detection signal Vedg in the mask processing time period is eliminated.

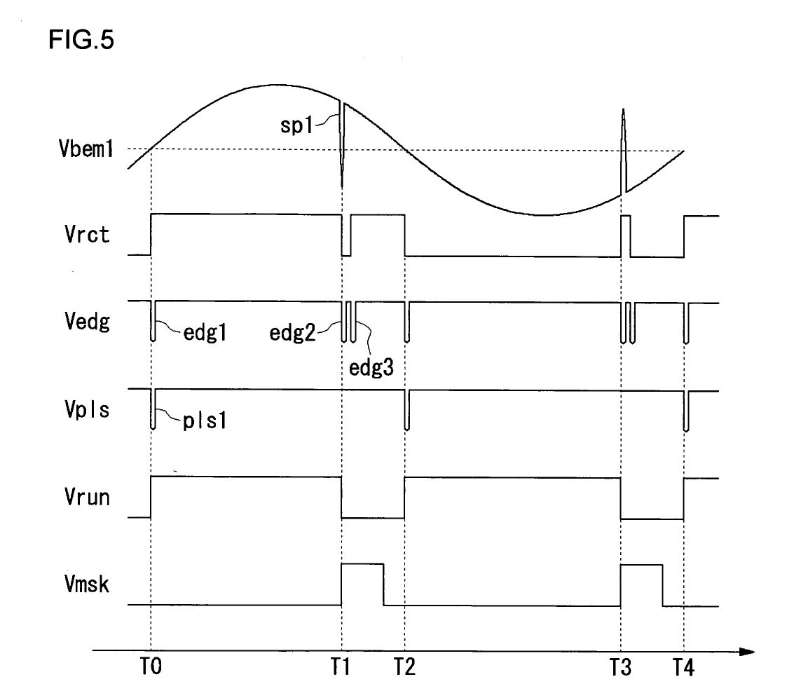

FIG. 5 is a timing chart of a mask processing operation in the pulse train generator 38 of FIG. 4. The timing chart of FIG. 5 shows, from the top, in order, a counter electromotive voltage Vbem1, the square wave signal Vrct, the edge detection signal Vedg, the pulse train Vpls, the energization signal Vrun, and the mask signal Vmsk. In the same figure, a vertical axis and a horizontal axis are enlarged or reduced, as appropriate.

At time T0, Vbem1>Vbem2, and the square wave signal Vrct transits from a low level to a high level. The edge detection circuit 14 detects a rising edge of the square wave signal Vrct, and outputs a pulse edg1. At this time, since the mask signal Vmsk has a low level, the pulse edg1 is not masked, but is outputted as a pulse pls1. The energization signal generator 20 shows a high level while the clock signal Vclk is counted M times from when the pulse pls1 has been created. At the time T1 at which M times have been counted, the energization signal Vrun transits to a low level. At this time, a voltage pulse sp1 having a spiked shape is created in the counter electromotive voltage Vbem1. The edge detection circuit 14 detects an edge created in the square wave signal Vrct by the voltage pulse sp1, and outputs pulses edg2 and edg3. On the other hand, since the mask signal generator 22 outputs the mask signal Vmsk at a high level, for a mask processing time period after the energization signal Vrun has transited to a low level, the mask circuit 16 eliminates pulses edg2 and edg3 in the mask processing time period, by a logic operation. As a result, the pulses edg2 and edg3 are not included in the pulse train Vpls. Fluctuation of the edge detection signal Vedg that accompanies the voltage pulse at time T3 is also eliminated by the mask circuit 16.

The electronic device 200 related to the second embodiment configured as above realizes operative effects the same as those mentioned in the first embodiment. In addition, according to the electronic device 200 of the second embodiment, since the mask processor 40 masks the pulse of the edge detection signal Vedg, in the mask processing time period after the energization signal Vrun has transited from a high level to a low level, even in cases in which noise such as the spike shaped pulse or the like enters the counter electromotive voltage, risk of malfunctions can be reduced. In addition, similarly to the first embodiment, since, if the number of revolutions of the motor 102 changes, the frequency of the clock signal Vclk also changes in proportion thereto, the mask processing time period for the edge detection signal Vedg is automatically controlled.

### Third Embodiment

In a third embodiment, in order to realize noise suppression and silencing, an explanation is given for cases in which a function is added to make fluctuations in drive current Iout gradual, at starting and stopping of energization in the motor 102. Furthermore, in cases of the third embodiment, N is a natural number, greater than or equal to 2.

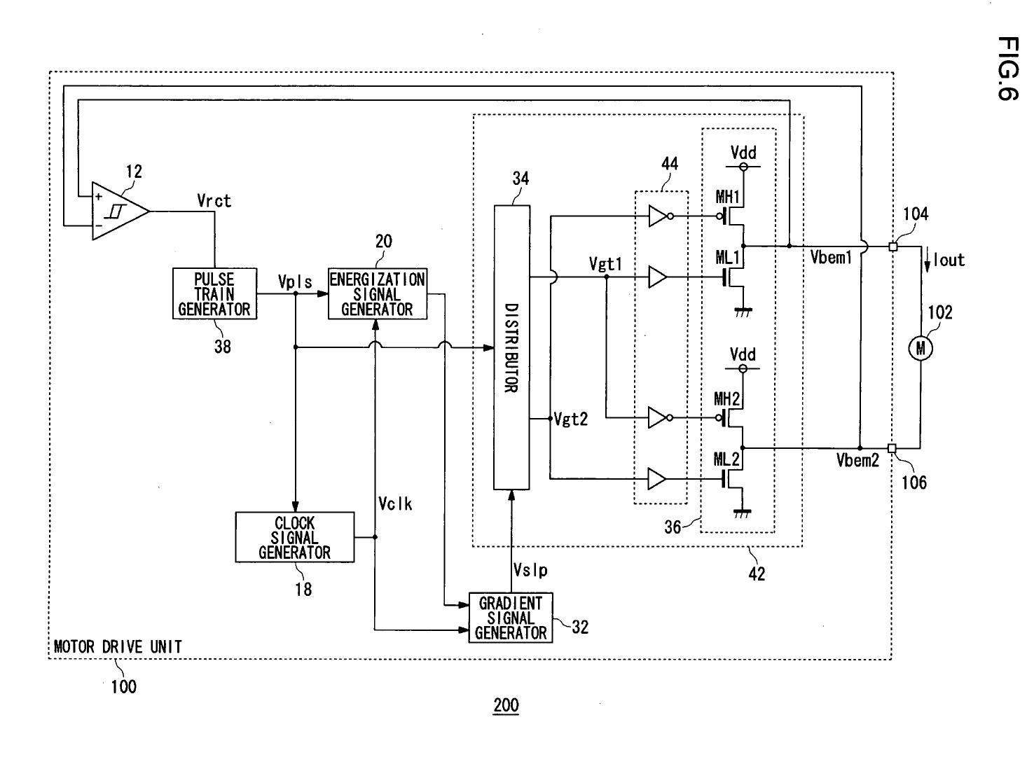

FIG. 6 shows a configuration of an electronic device 200 related to the third embodiment. In FIG. 6, constituent elements that are identical with or equivalent to constituent elements of FIG. 1 are given the same reference symbols, and explanations thereof are omitted as appropriate.

The electronic device 200 related to the third embodiment differs from that of the first embodiment principally in that a gradient signal generator 32 and a distributor 34 are additionally included.

The gradient signal generator 32 outputs a gradient signal Vslp whereby at an occasion when the energization signal Vrun rises, electrical potential gradually rises, and, after that, maintains a constant potential, and at an occasion when the energization signal Vrun falls, the potential gradually declines.

The distributor 34 alternately switches and outputs, every time the pulse train generator 38 creates a pulse, the gradient signal Vslp, as one of a first gate control signal Vgt1 or a second gate control signal Vgt2. For example, the distributor 34 is now assumed to output the gradient signal Vslp as the first gate control signal Vgt1. In this state, if a pulse of the gradient signal Vslp is created, after that, the distributor 34 outputs the gradient signal Vslp as the second gate control signal Vgt2.

In the period in which the first gate control signal Vgt1 and the second gate control signal Vgt2 are gradually changing, the first highside switch MH1, the first lowside switch ML1, the second highside switch MH2, and the second lowside switch ML2 function as variable resistances. For example, in cases in which the second gate control signal Vgt2 is gradually rising, the drive current Iout gradually rises as it flows from a first output terminal 104 towards a second output terminal 106. Conversely, in cases in which the second gate control signal Vgt2 gradually declines, the drive current Iout gradually becomes smaller as it flows from the first output terminal 104 towards the second output terminal 106.

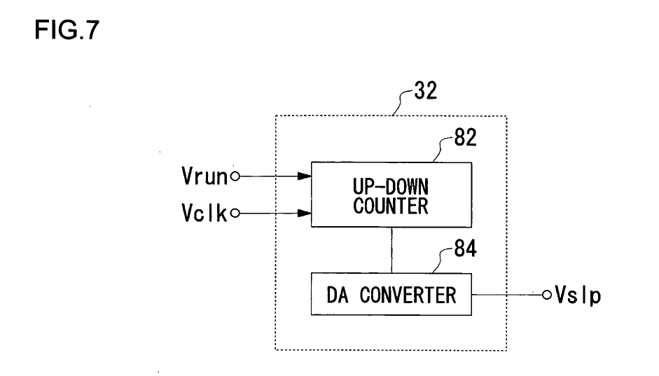

FIG. 7 shows a configuration of the gradient signal generator 32 of FIG. 6.

The gradient signal generator 32 includes an up-down counter 82, and a DA (Digital Analog) converter 84. The up-down counter 82 counts the clock signal Vclk upward, after the energization signal Vrun has transited from a low level to a high level. The up-down counter 82 counts the clock signal Vclk downward, after the energization signal Vrun has transited from a high level to a low level. The gradient signal generator 32 performs a DA conversion of the count value of the up-down counter 82 for each clock signal, and outputs the gradient signal Vslp. The upward count and the downward count are set, for example, at around 150 times, when N=1000. An optimal value may be determined by experiment.

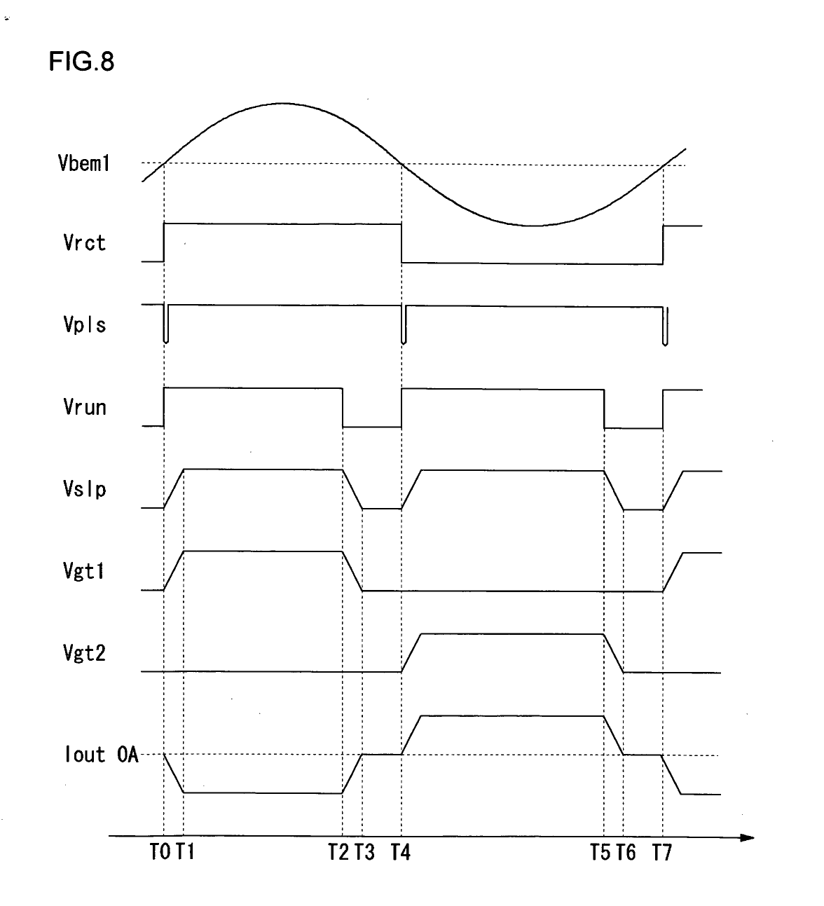

FIG. 8 is a timing chart showing operation of the electronic device 200 of FIG. 6. The timing chart of FIG. 8 shows, from the top, in order, a counter electromotive voltage Vbem1, a square wave signal Vrct, a pulse train Vpls, the energization signal Vrun, the gradient signal Vslp, the first gate control signal Vgt1, the second gate control signal Vgt2, and the drive current Iout. In the same figure, a vertical axis and a horizontal axis are enlarged or reduced, as appropriate.

When the energization signal Vrun rises at time T0, the up-down counter 82 begins an upward count, and continues the upward count until a time T1 is reached. Accordingly, during a time period from time T0 to T1, the gradient signal Vslp outputted from the DA converter 84 gradually rises. The distributor 34 outputs the gradient signal Vslp as the first gate control signal Vgt1, and the drive current Iout flows while gradually rising from the second output terminal 106 towards the first output terminal 104. During the period from time T1 to T2, the up-down counter 82 holds a count value, and the gradient signal Vslp maintains a constant level. Accordingly, during this period, the drive current Iout holds a constant level. At time T2, when the energization signal Vrun transits from a high level to a low level, the up-down counter 82 begins a downward count, and continues until time T3. Accordingly, the gradient signal Vslp declines gradually, and the first gate control signal Vgt1 also gradually declines in the same way. Accordingly, the drive current Iout gradually become smaller as it flows from the second output terminal 106 towards the first output terminal 104.

During a time period from time T3 to T4, from where the gradient signal Vslp is 0 V until at time T4 the energization signal Vrun rises, the drive current Iout is 0 A. When the energization signal Vrun rises at time T4, the up-down counter 82 begins an upward count. Accordingly, the gradient signal Vslp gradually rises. Here, the distributor 34 receives a pulse of the pulse train Vpls at time T4, and the gradient signal Vslp is now outputted as the second gate control signal Vgt2. Accordingly, the drive current Iout flows while gradually rising from the first output terminal 104 towards the second output terminal 106. In the period from time T4 to T5, the up-down counter 82 holds a count value, and the gradient signal Vslp maintains a constant level. Accordingly, during this period, the drive current Iout holds a constant level. At time T5, when the energization signal Vrun transits from a high level to a low level, the up-down counter 82 begins a downward count, and continues until time T6. Accordingly, during a time period from time T5 to T6, since the gradient signal Vslp gradually declines, the drive current Iout becomes smaller as it gradually flows from the first output terminal 104 towards the second output terminal 106. During the period from time T6 to T7, similarly to the period from time T3 to T4, the drive current Iout is 0 A.

The electronic device 200 related to the third embodiment configured as above realizes effects the same as those mentioned for the first embodiment. Furthermore, according to the electronic device 200 of the third embodiment, the gradient signal generator 32 outputs a gradient signal Vslp whereby at an occasion when the energization signal Vrun rises, electrical potential gradually rises, and, after that, maintains a constant potential, and at an occasion when the energization signal Vrun falls, the potential gradually declines; and since an output circuit 42 gradually changes the drive current Iout when energization is started and stopped, based on the gradient signal Vslp, generation of noise can be decreased and the motor 102 can be silenced.

### Fourth Embodiment

In a fourth embodiment, an explanation is given concerning an electronic device 200 having both the mask processing function of the second embodiment, and a function to gradually change the drive current Iout of the third embodiment. Furthermore, in cases of the fourth embodiment, N is a natural number, greater than or equal to 3.

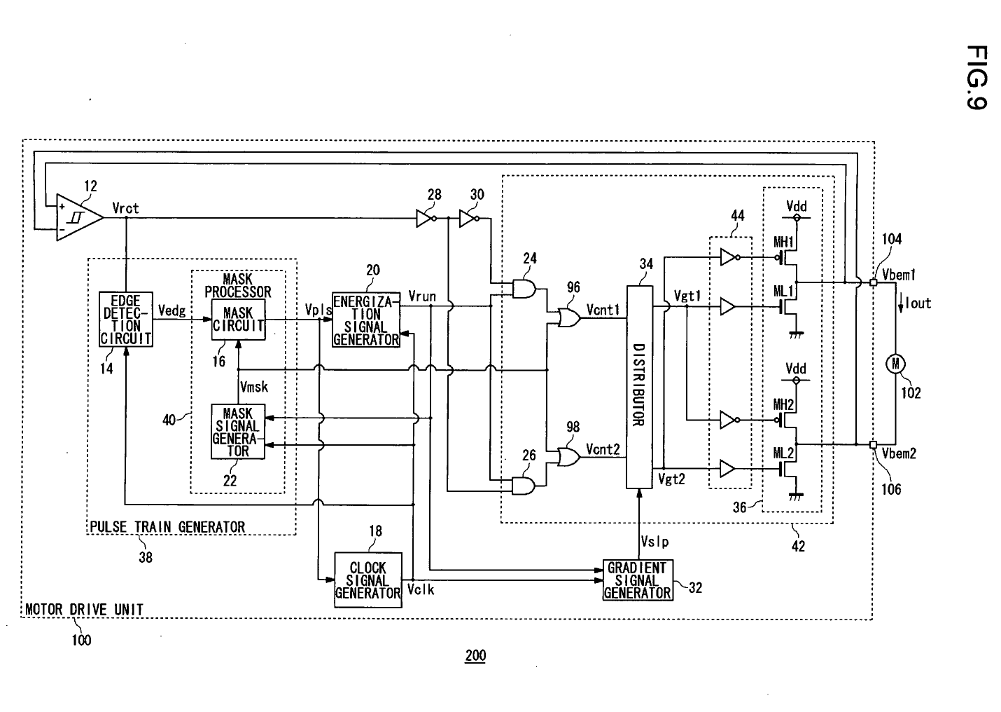

FIG. 9 shows a configuration of the electronic device 200 related to the fourth embodiment. In FIG. 9, constituent elements that are identical with or equivalent to constituent elements of FIG. 1, FIG. 4, and FIG. 6 are given the same reference symbols, and explanations thereof are omitted, as appropriate.

Output of AND gates 24 and 26 undergoes a logical OR operation with a mask signal Vmsk with respect to OR gates 96 and 98, and is outputted to a distributor 34 as a first distribution control signal Vcnt1 and a second distribution control signal Vcnt2.

When the first distribution control signal Vcnt1 has a high level, the distributor 34 outputs a gradient signal Vslp as a first gate control signal Vgt1. When the second distribution control signal Vcnt2 has a high level, the distributor 34 outputs the gradient signal Vslp as a second gate control signal Vgt2.

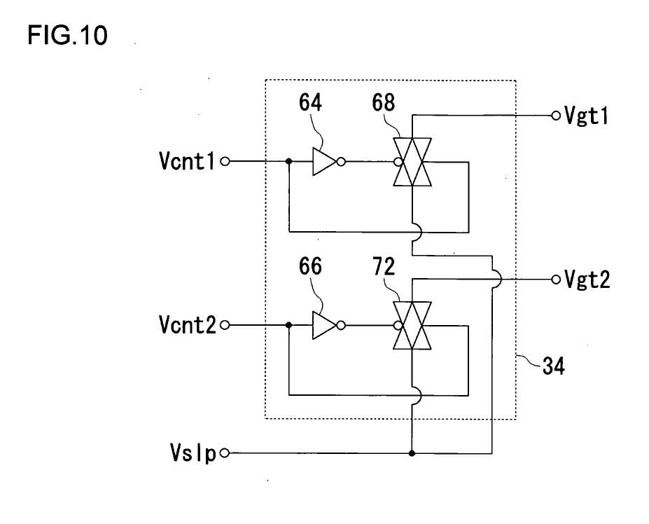

FIG. 10 shows a configuration of the distributor 34 of FIG. 9.

The distributor 34 includes NOT gates 64 and 66, a first transfer gate 68, and a second transfer gate 72. The first transfer gate 68 and the second transfer gate 72 are ON when the first distribution control signal Vcnt1 and the second distribution control signal Vcnt2 are at a high level, and are OFF when at a low level.

In a time period in which the first distribution control signal Vcnt1 has a high level, the first transfer gate 68 is ON, and the gradient signal Vslp is passed to be output as the first gate control signal Vgt1. On the other hand, the second transfer gate 72 is OFF, and the second gate control signal Vgt2 has a low level. In a time period in which the second distribution control signal Vcnt2 has a high level, the second transfer gate 72 is ON, and the gradient signal Vslp is passed to be output as the second gate control signal Vgt2. On the other hand, the first transfer gate 68 is OFF, and the first gate control signal Vgt1 has a low level.

The electronic device 200 of the fourth embodiment realizes similar effects to those mentioned in the first to the third embodiments. In addition, according to the electronic device 200 of the fourth embodiment, since use is made of a mask signal Vmsk created when the first distribution control signal Vcnt1 and the second distribution control signal Vcnt2 are generated, compared to cases in which another signal is created to control the distributor 34, the circuit size can be reduced.

The abovementioned embodiments are examples; various modifications of combinations of various component elements and various processes thereof are possible, and a person skilled in the art may understand that such modified examples are within the scope of the present invention.

In the second embodiment, the pulse train generator 38 performs mask processing in the mask processor 40, for the edge detection signal Vedg detected by the edge detection circuit 14 as an edge of the square wave signal Vrct; however, the pulse train generator 38, by eliminating noise constituents of the square wave signal Vrct by the mask processor 40, may detect the edge of the square wave signal Vrct by the edge detection circuit 14. That is, as a result, timing may be detected at which counter electromotive voltage occurring at the two ends of the coil is 0 V.

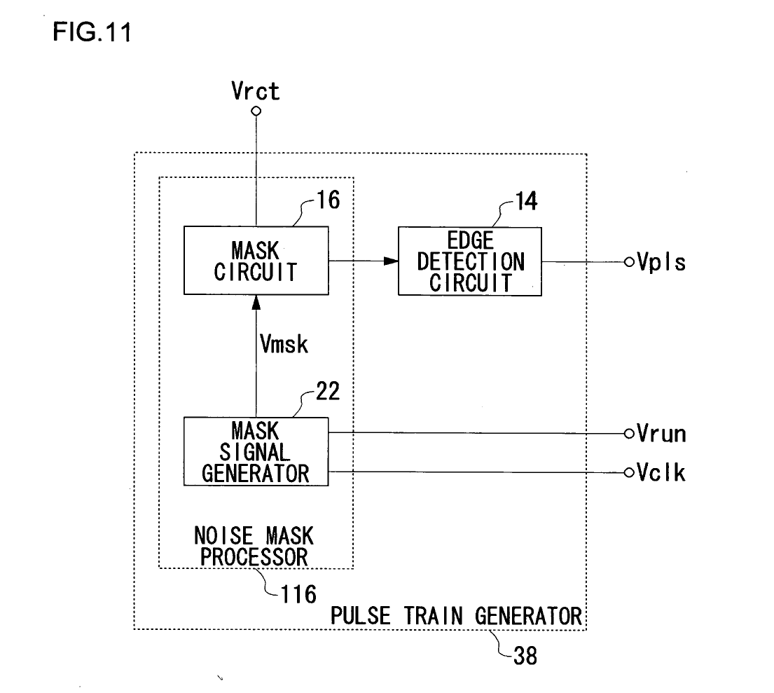

FIG. 11 shows a configuration of the pulse train generator 38 related to a modified example.

The pulse train generator 38 includes a noise mask processor 116, and the edge detection circuit 14. The noise mask processor 116 includes a mask circuit 16, and a mask signal generator 22. The noise mask processor 116 nullifies transition of level of the square wave signal Vrct, for a mask processing time period in which a clock signal Vclk is counted L times, after the energization signal Vrun transits from a high level to a low level. The edge detection circuit 14 creates a pulse every time an edge of a square wave signal, outputted from the noise mask processor 116, is detected, and generates an edge detection signal Vedg. The generated edge detection signal Vedg is output as a pulse train Vpls.

According to the present modified example, since the edge detection circuit 14 detects the edge of the square wave signal Vrct in which the transition of level has been nullified during the mask processing time period, risk of malfunctions is reduced by detecting the edge produced by noise. In addition, similarly to the second embodiment, since, if the number of revolutions of the motor 102 changes, the frequency of the clock signal Vclk also changes in proportion thereto, the time period in which the transition of level of the square wave signal Vrct is nullified, is automatically controlled.

In the third embodiment, the gradient signal generator 32 is configured from the up-down counter 82 and the DA converter 84; however, this should not be considered as limiting.

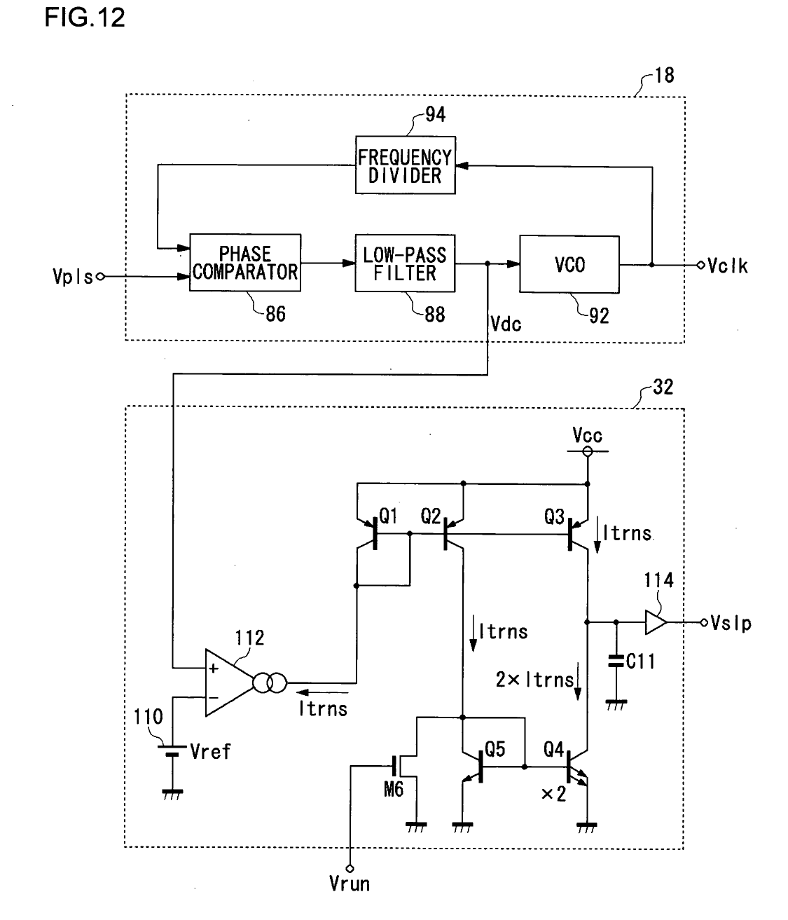

FIG. 12 is a configuration of the gradient signal generator 32 and a clock signal generator 18 related to the modified example. Since the clock signal generator 18 has a well known configuration, the explanation is confined to only an outline. The clock signal generator 18 includes a phase comparator 86, a low-pass filter 88, a VCO (Voltage Controlled Oscillator) 92, and a 1/N frequency divider 94. The phase comparator 86 outputs a signal of a size according to phase difference of the clock signal Vclk divided by N and the pulse train Vpls. The low-pass filter 88 eliminates a high-frequency component of the signal and outputs a direct current signal Vdc.

The gradient signal generator 32 includes a reference voltage source 110, a conductance amplifier 112, a first transistor Q1, a second transistor Q2, a third transistor Q3, a fourth transistor Q4, a fifth transistor Q5, a sixth transistor M6, a capacitor C11, and a buffer 114. The conductance amplifier 112 and the first transistor Q1 to the sixth transistor M6 compose a charge-discharge unit for charging and discharging the capacitor C11. The first transistor Q1 to the third transistor Q3 are PNP type bipolar transistors, and the fourth transistor Q4 and the fifth transistor Q5 are NPN type bipolar transistors. Furthermore, the sixth transistor M6 is a N-channel MOSFET.

An inverted input terminal of the conductance amplifier 112 is connected to the reference voltage source 110. A non-inverted input terminal of the conductance amplifier 112 is connected to the low-pass filter 88 and the VCO 92. The conductance amplifier 112 transforms a difference between a reference voltage Vref and the direct current signal Vdc into a current. The larger Vdc is compared to Vref, the larger the transformed current. The current outputted from the conductance amplifier 112 is referred to as a transformed current Itrns.

The first transistor Q1 is arranged on a current path of the transformed current Itrns. The first transistor Q1, the second transistor Q2, and the third transistor Q3, to which a base and an emitter terminal are commonly connected, compose a current mirror circuit. Transistor size of the first transistor Q1 the second transistor Q2, and the third transistor Q3 are equivalently configured, and a current of an amount equal to the transformed current Itrns flows in the second transistor Q2 and the third transistor Q3.

The fifth transistor Q5 and the fourth transistor Q4 are, respectively, arranged on the current path of the second transistor Q2 and the third transistor Q3. The fifth transistor Q5 and the fourth transistor Q4, to which a base and an emitter terminal are commonly connected, compose a current mirror circuit. The transistor size of the fourth transistor Q4 is configured to be twice the transistor size of the fifth transistor Q5.

A drain of the sixth transistor M6 is connected to the base and collector of the fifth transistor Q5, and to the base of the fourth transistor Q4. The energization signal Vrun is input to a gate that is a control terminal of the sixth transistor M6.

Collector terminals of the third transistor Q3 and the fourth transistor Q4 are connected to one end of the capacitor C11. The other end of the capacitor C11 is grounded. Voltage occurring in the capacitor C11 is output, via the buffer 114, as the gradient signal Vslp.

When the energization signal Vrun has a high level, the sixth transistor M6 is ON, and the fifth transistor Q5 and the fourth transistor Q4 are OFF. At this time, since the first transistor Q1, the second transistor Q2, and the third transistor Q3 compose a current mirror, a current of the same size as the transformed current Itrns flows in the third transistor Q3. At this time, since a current is not flowing in the fourth transistor Q4, the capacitor C11 is charged by the current Itrns flowing in the third transistor Q3, and the gradient signal Vslp gradually rises at a constant gradient.

In cases in which the energization signal Vrun has a low level, the sixth transistor M6 is OFF. At this time, since the fifth transistor Q5 and the fourth transistor Q4 compose a current mirror with a mirror ratio of 1:2, a current of the same size as the transformed current Itrns, flows in the fifth transistor Q5, and a current of twice the size flows in the fourth transistor Q4. A current flowing in the third transistor Q3 is also the same size as the transformed current Itrns. When the energization signal Vrun has a low level, the capacitor C11 is charged by the current Itrns flowing in the third transistor Q3, and, at the same time, is discharged by a current of 2×Itrns flowing in the fourth transistor Q4. As a result, the charge accumulated in the capacitor C11 is discharged at a current Itrns (=2×Itrns−Itrns), and the gradient signal Vslp decreases gradually at a gradient the same as the one mentioned earlier.

According to the present modified example, since the charge-discharge unit adjusts the current by which the capacitor C11 is charged, by the direct current signal Vdc input to the VCO 92, when the number of revolutions of the motor 102 changes, the charging current corresponding to this change can be supplied to the capacitor C11. Furthermore, the size of the circuit of the gradient signal generator 32 can be reduced.

What is claimed is:

1. A motor drive unit comprising:
a comparator for comparing a voltage occurring at two ends of a coil of a single phase motor, and outputting a square wave signal;
a pulse train generator for creating a pulse every time an edge of the square wave signal is detected, and for generating a pulse train; and
an energization signal generator for dividing a period of the pulse train at a prescribed ratio into a first half and a latter half by counting a clock count of a clock signal that has a frequency proportional to a number of revolutions of the single phase motor, and for generating an energization signal having a first level designating energization of the coil in the first half, and a second level designating non-energization of the coil in the latter half.

2. A motor drive unit according to claim 1, further comprising:
a clock signal generator for generating the clock signal having a frequency that is N times (N being a natural number greater than or equal to 2) a frequency of the pulse train, wherein the energization signal generator generates an energization signal having the first level, for a time period in which the clock signal is counted M times after the pulse has been created (M being a natural number, M<N), and, after that, having the second level, for a time period in which the clock signal is counted (N−M) times.

3. A motor drive unit according to claim 1, wherein the pulse train generator comprises:
an edge detection circuit for creating a pulse every time an edge of the square wave signal is detected, and generating the pulse train; and
a mask processor for masking the pulse, for a prescribed noise elimination time period.

4. A motor drive unit according to claim 2, wherein the pulse train generator comprises:
an edge detection circuit for creating a pulse every time an edge of the square wave signal is detected, and generating the pulse train; and
a mask processor for masking the pulse, for a prescribed noise elimination time period.

5. A motor drive unit according to claim 4, wherein the mask processor masks the pulse for a time period in which the clock signal is counted L times (the N being a natural number greater than or equal to 3, L being a natural number, L<(N−M)), after the energization signal has transited from the first level to the second level.

6. A motor drive unit according to claim 1, wherein the pulse train generator comprises:
a mask processor for nullifying transition of level of the square wave signal, for a prescribed noise elimination time period; and
an edge detection circuit for creating a pulse every time an edge of the square wave signal, outputted from the mask processor, is detected, and for generating the pulse train.

7. A motor drive unit according to claim 2, wherein the pulse train generator comprises:
a mask processor for nullifying transition of level of the square wave signal, for a prescribed noise elimination time period; and
an edge detection circuit for creating a pulse every time an edge of the square wave signal, outputted from the mask processor, is detected, and for generating the pulse train.

8. A motor drive unit according to claim 7, wherein the mask processor nullifies transition of level of the square wave signal, for a time period in which the clock signal is counted L times (the N being a natural number greater than or equal to 3, L being a natural number, L<(N−M)), after the energization signal has transited from the first level to the second level.

9. A motor drive unit according to claim 1, further comprising:
a gradient signal generator for outputting a gradient signal in which electrical potential gradually changes at an occasion of transition of level of the energization signal; and
an output circuit for gradually changing a drive current supplied to the coil of the single phase motor based on the gradient signal.

10. A motor drive unit according to claim 2, further comprising:
a gradient signal generator for outputting a gradient signal in which electrical potential gradually changes at an occasion of transition of level of the energization signal; and
an output circuit for gradually changing a drive current supplied to the coil of the single phase motor based on the gradient signal.

11. A motor drive unit according to claim 9, wherein the gradient signal generator comprises:
an up-down counter for counting up and counting down according to transition direction when the energization signal transits between the first level and the second level; and
a digital-analog conversion circuit for converting a count value of the up-down counter to an analog signal, wherein an output signal of the digital-analog conversion circuit is output as the gradient signal.

12. A motor drive unit according to claim 10, wherein the gradient signal generator comprises:
an up-down counter for counting up and counting down according to transition direction when the energization signal transits between the first level and the second level; and
a digital-analog conversion circuit for converting a count value of the up-down counter to an analog signal, wherein an output signal of the digital-analog conversion circuit is output as the gradient signal.

13. A motor drive unit according to claim 1, integrated on one semiconductor board.

14. An electronic device comprising a single phase motor and a motor drive unit according to claim 1, for driving the single phase motor.
